(19) United States
(12) Patent Application Publication
(10) Pub. No.: US 2012/0019460 A1
(43) Pub. Date: Jan. 26, 2012

(54) INPUT METHOD AND INPUT APPARATUS

(75) Inventors: Takashi MATSUBARA, Chigasaki (JP); Setiawan BONDAN, Yamato (JP)

(73) Assignee: Hitachi Consumer Electronics Co., Ltd.

(21) Appl. No.: 13/085,536

(22) Filed: Apr. 13, 2011

(30) Foreign Application Priority Data
Jul. 20, 2010 (JP) 2010-162417

(51) Int. Cl. G06F 3/041

(52) U.S. Cl. 345/173

(57) ABSTRACT

An input apparatus, in particular, of a type for enabling an input operation in a contactless manner, smoothly, as is intended by a user, comprises a distance detector means for detection a distance from that input apparatus to a user's hand, a distance change detector means for detecting change of distance upon basis of a result of detection by the distance detector unit, and an instruction output means for providing an instruction to an apparatus of an outside, upon basis of a result of detection by the distance change detector means, wherein the distance change detector means detects that the distance is changed, starting from a predetermined first distance, as a beginning of the change of distance, reaching to a second distance, and the instruction output means treats the result of detection by the distance change detector means as an operation made by the user, and thereby providing the instruction to the apparatus of an outside.

This application relates to and claims priority from Japanese Patent Application No. 2010-162417 filed on Jul. 20, 2010, the entire disclosure of which is incorporated herein by reference.

### BACKGROUND OF THE INVENTION

The present invention relates to an input apparatus, and an input method thereof, and it relates to an input apparatus for detecting a distance between an operating hand of a user and a screen operated by a sensor, thereby applying an operation instruction depending on a result of detection.

Conventionally, it is common that the user makes an operation upon channel/display through a remote controller, and/or makes an input of a command or data through an input device, such as, a keyboard, a mouse or a touch panel, etc., to an video apparatus, such as, a TV or recorder, or information processing equipments, such as a PC, etc.

Also, in recent years, due to an improvement of a technology of a sensor, in particular, in a field of game machines and/or portable equipments, there is applied a method for recognizing a movement of the user by a sensor, so as to determined an intention of the user depending on a result thereof; thereby operating the equipment.

In the Patent Document 1 is disclosed a video recognizing apparatus for recognizing a shape or operation of a hand or a finger, thereby determining an operation.

Within the video recognizing apparatus disclosed in the Patent Document 1, an operation surface is produced depending on the position of a user body, while a user gives an instruction to the apparatus, through the position or the movement of hands or fingers with respect to that operation surface. The operation surface mentioned above is a virtual operation surface, wherein an operator 102 can make an input operation, easily, by pushing out her/his hand(s) while assuming the virtual operation surface from a marker 101, or by moving her/his hand(s) to touch thereon while comparing or considering a part on the screen and the operation surface as the touch panel, in an engagement with a monitor 111. (paragraph number 0033)<

### PRIOR ART DOCUMENTS

### Patent Documents

[Patent Document 1] Japanese Patent No. 4318056.

### BRIEF SUMMARY OF THE INVENTION

However, in the Patent Document 1, although consideration is paid on an operation upon the operation surface in parallel with the screen; however no consideration is paid on an operation in the direction perpendicular to that screen.

Then, the present invention, accomplished by taking such situations into the consideration thereof, an object thereof is to provide an input method and an input apparatus for enabling a user to make an operation, intuitively much more, by taking the movement in the direction perpendicular to the display screen, when the user makes an operation.

For accomplishing the object mentioned above, according to the present invention, there is provided an input method and a input apparatus described in the claims, which will be mentioned later, for example. Of such structures, in the input apparatus for executing an input operation in a contactless or contact-free manner, detection is made on a distance between a user's hand and a display screen to be operated, and an input operation is executed depending on that distance.

According to the present invention, the user can grasp her/his operation, institutively, such as, change of an operation target, which is executed depending on the distance between an operating hand of the user and the display screen, and therefore it is possible to input an operation as the user intends.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is an overview for showing an input apparatus, according to an embodiment 1 of the present invention;

FIG. 2 is a block diagram for showing the structure of the input apparatus according to the embodiment 1;

FIG. 3 is an overview for showing an operating area of the input apparatus according to the embodiment 1 and an operating method by a user;

FIG. 4 is an overview for explaining correspondence between user operations of the input apparatus according to the embodiment 1 and an operation results;

FIG. 5 is a flowchart for explaining the operations of the input apparatus according to the embodiment 1;

FIG. 6 is an overview for explaining an operating area of the input apparatus according to the embodiment 1 and the operating method by a user;

FIG. 7 is an overview for showing an operating area of an input apparatus according to an embodiment 2 and an operating method by a user;

FIG. 8 is an overview for explaining an operating area of the input apparatus according to the embodiment 2 and the operating method by a user;

FIG. 9 is a flowchart for explaining the operations of the input apparatus according to the embodiment 2;

FIG. 10 is an overview for showing an input apparatus, according to an embodiment 3 of the present invention;

FIG. 11 is a block diagram for showing the structure of the input apparatus according to the embodiment 3;

FIG. 12 is an overview for showing an operating area of the input apparatus according to the embodiment 3 and an operating method by a user;

FIG. 13 is a flowchart for explaining the operations of the input apparatus according to the embodiment 3;

FIG. 14 is an overview for showing an operating area of the input apparatus according to an embodiment 4 and an operating method by a user; and

FIG. 15 is a flowchart for explaining the operations of the input apparatus according to the embodiment 4.

### DETAILED DESCRIPTION OF THE PREFERRED EMBODIMENTS

Hereinafter, embodiments according to the present invention will be fully explained by referring to the attached drawings.

### Embodiment 1

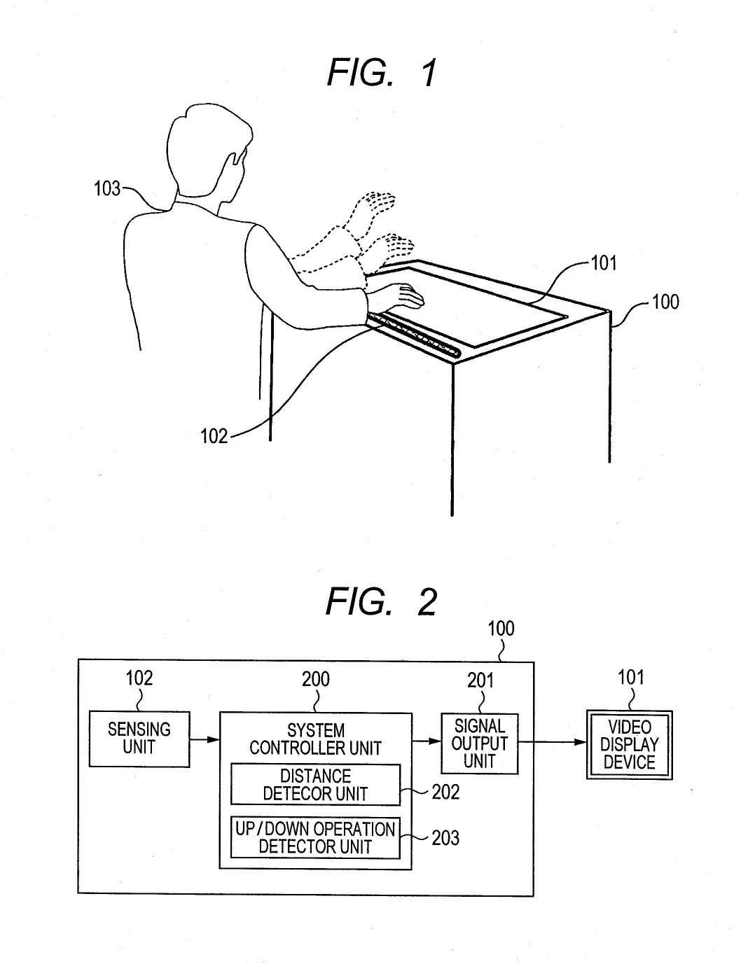

Hereinafter, explanation will be mad on a first embodiment of the present invention, by referring to FIGS. 1 through 5. An input apparatus 100 according to the present embodiment is an apparatus for detecting a distance between an operating hand of a user and a display screen 101 by a sensor, and thereby giving an instruction of the operation to the display screen 101 depending on that distance.

First of all, explanation will be given on the input apparatus, according to an embodiment of the present invention, by referring to FIGS. 1 and 2.

FIG. 1 shows an overview of an operating environment when a user 103 uses the input apparatus 100, with using the display screen 101 and a sensing unit 102.

The display screen 101 is a device for displaying video information to the user, upon basis of an operation input signal, which is given from an outside of the display screen, and is the apparatus having a display device, for example, a LCD (Liquid Crystal Display), a PDP (Plasma Display Panel), a liquid crystal projector, a laser projector or a rear projection, etc., and also a calculation processor device and a memory, as well, which are necessary for display processing, such as, video contents or GUI (Graphic User Interface), etc.

The sensing unit 102 is a unit for detecting the distance between the hand of the user and the sensor, and is built up with a sensor, such as, an infrared distance sensor, a laser distance sensor, an ultrasonic distance sensor, a distance video sensor or an electric field sensor, etc., a micro-computer for processing data, and software operating on that micro-computer. The sensor to be applied in the sensing unit 102 should not be limited to, in particular, and may have a function for converting a signal obtained for detecting the distance up to the hand of the user into distance data.

The user 103 is a user who makes an operation on the input apparatus 100.

The input apparatus 100, as is shown in FIG. 2, comprises the sensing unit 102, a system controller unit 200 and a signal output unit 202.

The system controller unit 200 has a distance detector unit 202 and an up/down operation detector unit 203.

The distance detector unit 202 extracts or classifies the distance, which is detected as an operation, from the distance data obtained from the sensing unit 102. The up/down operation detector unit 203 detects an operation of movement of a hand, up or down, by the user 103.

The system controller unit 200 detects the distance of the hand of the user 103, and executes data processing for detecting the operation of moving the hand up/down. The system controller unit 200 may be achieved by a CPU executing a software module memorized on a memory, or may be achieved by a hardware circuit for exclusive use thereof.

The single output unit 201 receives an instruction and data from the system controller unit 200, and outputs an operation input signal for indicating or instructing an operation to the display screen 101.

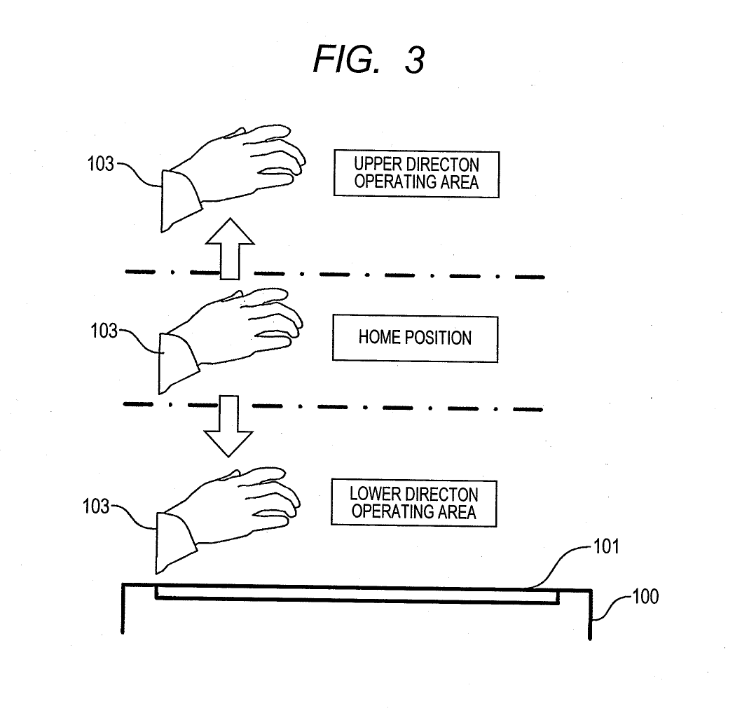

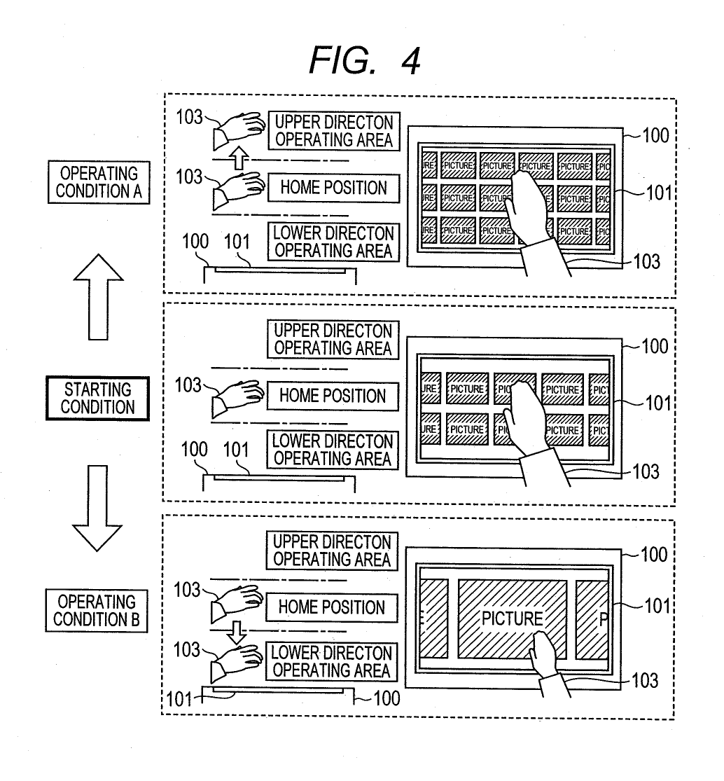

Next, explanation will be made on an operating method with using the input apparatus according to the first embodiment of the present invention, by referring to FIGS. 3 and 4.

FIG. 3 is an overview for explaining an operating area or region on the input apparatus 100 according to the first embodiment of the present invention, and the operating method by the user. As is shown in FIG. 3, the input apparatus 100 detects where the hand locates within three (3) operation areas or regions, i.e., an upper direction operation area shown in FIG. 3, a home position shown in FIG. 3, and a lower direction operation area shown in FIG. 3, upon basis of the distance of the hand of the user, which is obtained from the sensing unit 102. The operation areas are imaginary areas or regions for explaining the detecting method of the operation by the user 103, and they a assumed to exist in a space in vicinity of the hand, depending in the position where the user 103 holds up.

FIG. 4 is an overview for explaining correspondence between the user operation and an operation result, according to the first embodiment of the present invention. In this FIG. 4, a display is made on the display screen 101 for listing up pictures, and there is shown a manner of changing sizes of the pictures to be listed up and a number of the displays thereof, depending on the operation made by the user 103.

As an operation image of the input apparatus 100, according to the first embodiment of the present invention, as is shown in FIG. 4, it is such that the user 103 makes an operation with using her/his hand while watching the display screen 101, then the input apparatus 100 detects the distance up to that hand, and a display on the display screen 101 is changed upon basis of a result of that detection. For example, as is shown by (starting condition) in FIG. 4, it is assumed that the hand of the user 103 is at the position of (home position) shown in FIG. 4. Next, as is shown by (operating condition A) in FIG. 4, when the user moves her/his hand from the position, (home position) shown in FIG. 4, to (upper direction operating area) shown in FIG. 3, then in the list of pictures displayed on the display screen 101, the size of each picture becomes small, and at the same time, a number of the pictures displayed thereon becomes large. On the other hand, when the user makes her/his hand move from the position, (home position) shown in FIG. 4, to (lower direction operating area) shown in FIG. 3, then in the list of pictures displayed on the display screen 101, the size of each picture becomes large, and at the same time, the number of the pictures displayed thereon becomes small. Thus, when the position at which the hand of the user 103 is detected is moved from (home position) in FIG. 4, to (upper direction operating area) in FIG. 3 or (lower direction operating area) in FIG. 3, the input apparatus 100 gives an instruction, depending on the moving direction of the hand of the user 103, to the display screen 101, and thereby the display on the display screen 101 is changed.

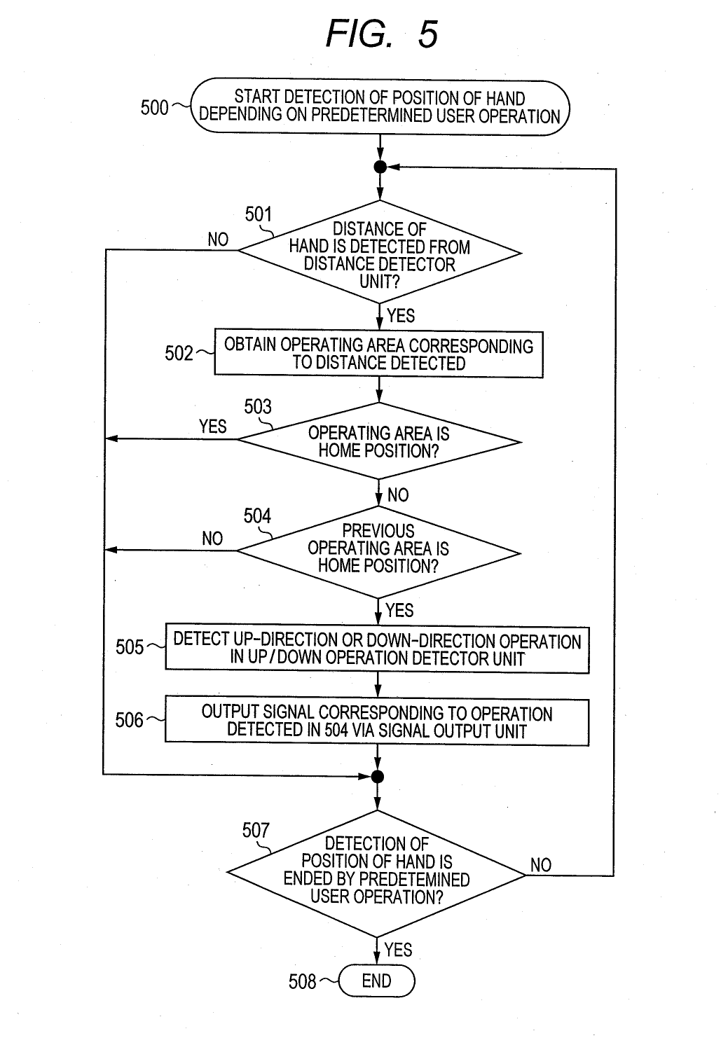

Next, explanation will be given about steps of a process for detecting an input operation made by the input apparatus 100, according to the first embodiment of the present invention, by referring to a flowchart shown in FIG. 5.

The detecting process of the input operations is executed by the system controller unit 200 shown in FIG. 2.

First of all, the system controller unit 200, starting detection of the position of the hand, responding to a predetermined user operation (step 500), executes a process for extracting or classifying the distance, which is detected as an operation, from the distance data obtained from the sensing unit 102 in the distance detector unit 202, and thereby detecting the distance of the hand. When the distance of the hand is detected (step 501), an operating area corresponding to the distance detected is obtained (step 502).

In case where the operating area where the hand locates is the home position (Yes: step 503), detection is continued of the distance of the hand. On the other hand, if the operating area where the hand locates is not the home position (No: step 503), firstly, it is confirmed that the operating area where the hand locates, which was detected in a previous detection, is the home position (Yes: step 504), and then detection is made of the operation if an upper direction or a lower direction, in the up/down operation detector unit (step 505). In this instance, if the operating area, which was detected in the previous detection, is not the home position (No: step 504), then detection is continued of the distance of the hand, as in those described from the step 501 and thereafter. Namely, detection is made on the operation, only when the operation area where the hand locates moves from the home position to other operating area.

When detection the operation of upper direction or the lower direction, the operation input signal for indication an operation on the display screen 101, responding to the operation detected, through the signal output unit 201.

When the user 103 shows an intention of ending the operation (step 507), through a predetermined operation, then the process is ended, and if not so, detection is continued of the distance of the hand, as in those described from the step 501 and thereafter.

In this manner, the input apparatus 100 detects the operation responding to change of the distance up to the hand, which is held up by the user 103 towards the display screen 101, and gives an instruction of operation to the display screen 101. With this, the user 103 can grasp the correspondence between the distance of the hand and the operation, intuitively, from the relationship of distance between the physical apparatus and the hand, and thereby is able to input the operation that the user 103 intends, smoothly.

### Embodiment 2

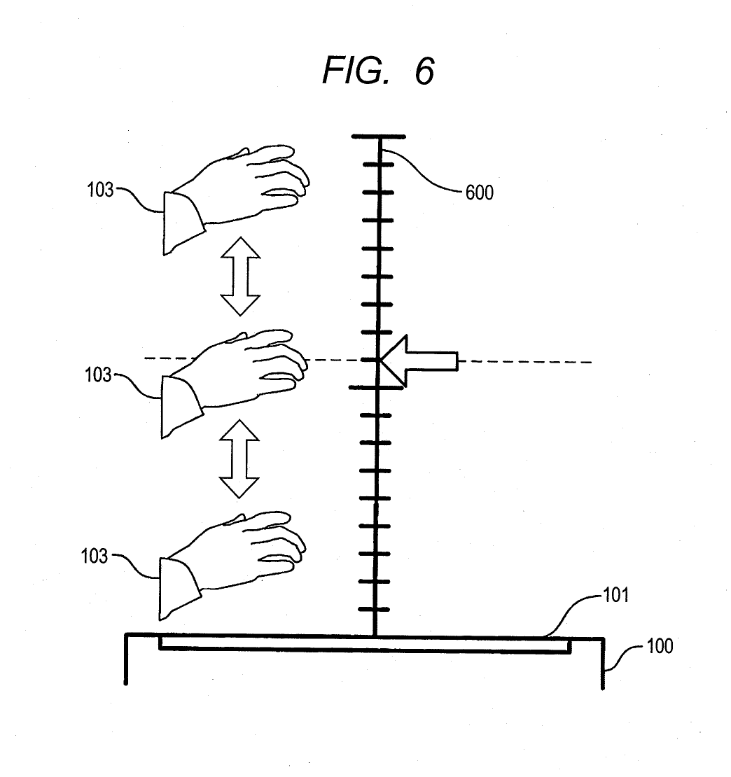

Hereinafter, explanation will be given about a second embodiment according to the present invention, by referring to FIGS. 6 through 9.

The display controlling method of the input apparatus 100 according to the first embodiment is to provide an interface for executing the operation depending on change of the operating area where the hand locates. According to the present embodiment, in addition to the operation method of the first embodiment, there is further provided an interface for executing the operation depending on change of a relative distance between the hand and the input apparatus 100.

Also, the input apparatus 100 according to the present embodiment, as was shown in FIG. 2, is constructed with the sensing unit 102, the system controller unit 200 and the signal output unit 201, similar to the first embodiment; however, it differs therefrom only in an aspect that the system controller unit 200 makes detection in the up/down operation detector unit.

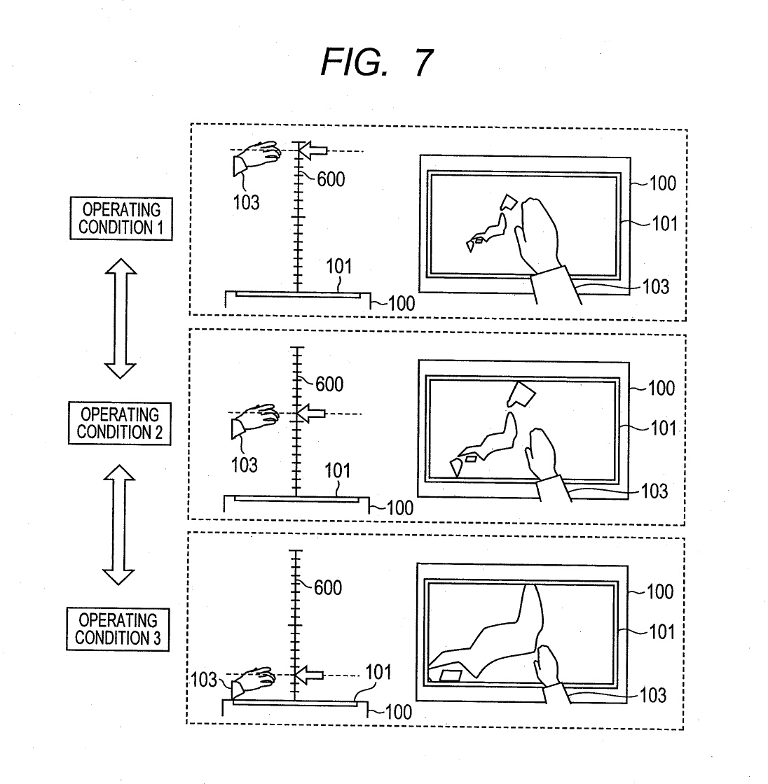

First of all, explanation will be given about the operating method of the input apparatus 100 according to the second embodiment of the present invention, by referring to FIGS. 6 and 7. In particular, FIG. 6 is an overview for explaining an operation standard or criterion and an operating method by the user on the input apparatus according to the second embodiment of the present invention.

As is shown in FIG. 6, the input apparatus 100 detects the position where the hand locates, with respect to an operation standard or criterion 600 for measuring a magnitude, quantity or length, etc., reflected on the operation, upon basis of the distance of the hand of the user, which is obtained from the sensing unit. The operation criterion 600 mentioned above is an imaginary criterion for use of explaining the detecting method of operation by the user 103, and it is assumed to exist in a space in vicinity of the hand, depending on the position where the user holds up her/his hand.

FIG. 7 is an overview for explaining the correspondence between a user operation and an operation result, according to the second embodiment of the present invention. In this FIG. 7, a map is displayed on the display screen, and there is also shown a situation where a scale of the map is changed responding to the operation by the user 103.

As an operation image of the input apparatus 100, according to the second embodiment of the present invention, as is shown in FIG. 7, it is such that, the user 103 makes an operation with using her/his hand while watching the display screen 101, then the input apparatus 100 detects the distance up to that hand, and a display on the display screen 101 is changed upon basis of a result of that detection. For example, as is shown by “operating condition 1” in FIG. 7, it is assumed that the hand of the user 103 is at the position in vicinity of an upper part of the operation criterion 600. Next, as is shown by “operating condition 2” in FIG. 7, when the user moves her/his hand into the vicinity of a middle part of the operation criterion 600, then the scale of the map displayed on the display screen is enlarged. Further, as is shown by “operation condition 3” in FIG. 7, when the user 103 moves her/his hand into the vicinity of a lower part of the operation criterion 600, then the scale of the map displayed on the display screen 101 is further enlarged, much more.

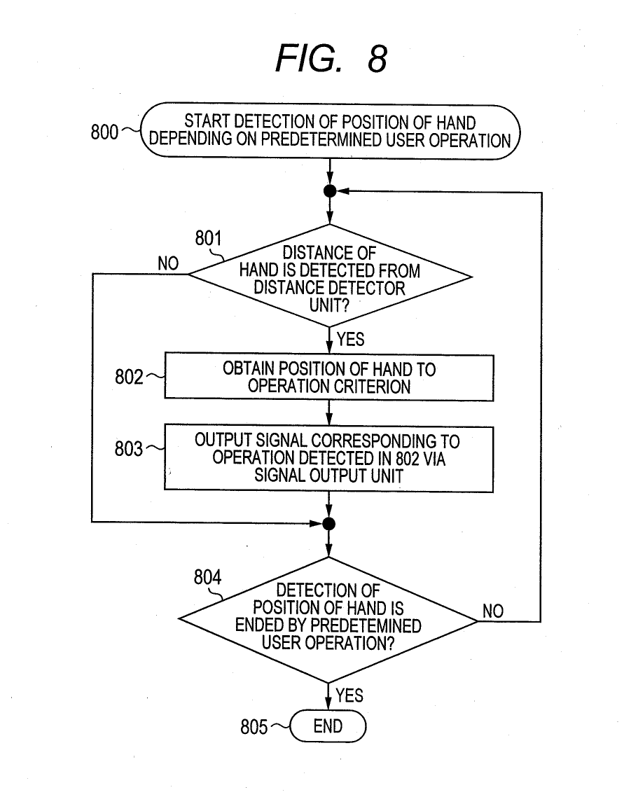

Next, explanation will be made about steps of a process for detecting an input operation made by the input apparatus 100, according to the second embodiment of the present invention, by referring to a flowchart shown in FIG. 8.

The detecting process of the input operations is executed by the system controller unit 200 shown in FIG. 2.

First of all, the system controller unit 200, starting detection of the position of the hand, responding to a predetermined user operation (step 800), executes a process for extracting or classifying the distance, which is detected as an operation, from the distance data obtained from the sensing unit 102 in the distance detector unit 202, and thereby detecting the distance of the hand. When the distance of the hand is detected (step 801), a position with respect to the operation criterion is obtained (step 802).

Next, the scale of the map is calculated from the relative position of the hand detected, to the operation criterion 600, in the signal output unit 201, and an operation input signal, indicating an operation to change the scale of the map, is outputted on the display screen 101.

When the user 103 shows an intention of ending the operation (step 804), through a predetermined operation, then process is ended, and if not so, detection is continued of the distance of the hand, as in those described from the step 801 and thereafter.

In this manner, the input apparatus 100, according to the second embodiment of the present invention, detects the position of the hand with respect to the operation criterion, depending on change of the distance up to the hand, which is held up by the user 103 towards the input apparatus 100, and the magnitude, quantity or length, etc., which can be defined by the position of the hand with respect to the operation criterion 600. With this, the user 103 is able to grasp the correspondence between the distance of her/his hand and the quantity, such as, the magnitude, length, depth, scale, etc., institutively, from a relationship between the physical apparatus and the hand, and thereby is able to input the operation that the user 103 intends, smoothly.

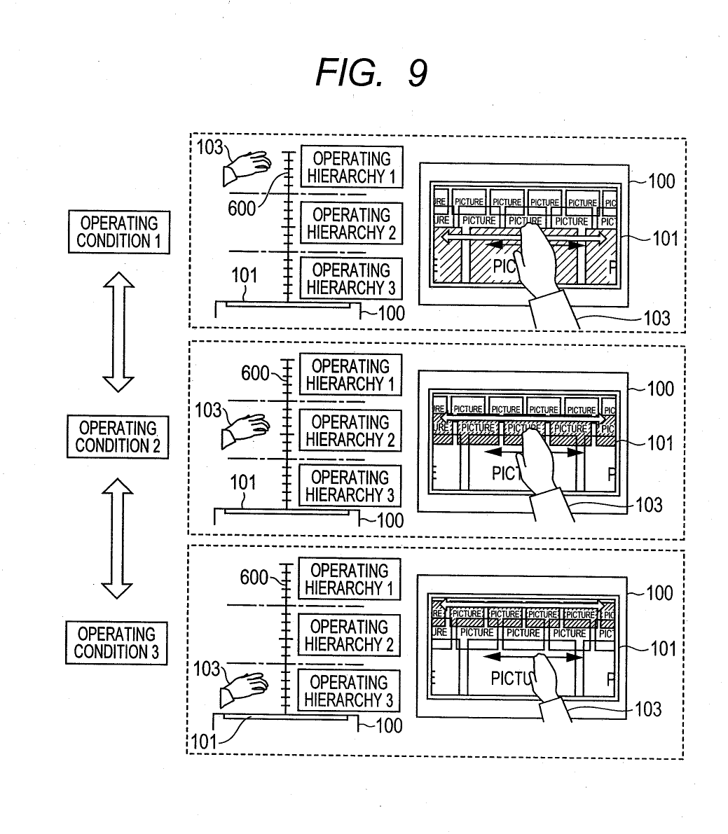

Also, the inputting operation mentioned above is effective for the operation on a menu made up with plural numbers of layers or hierarchies. As shown in FIG. 9, when menu made up with plural numbers of hierarchies is displayed, the hierarchy as an operation target can be changed by the position of the hand, with assigning the hierarchy to the operation criterion. With this, the user 103 is able to grasp the correspondence between the distance of her/his hand and the hierarchy of the operation target, from a relationship between the physical apparatus and the hand, and thereby is able to input the operation that the user 103 intends, smoothly.

### Embodiment 3

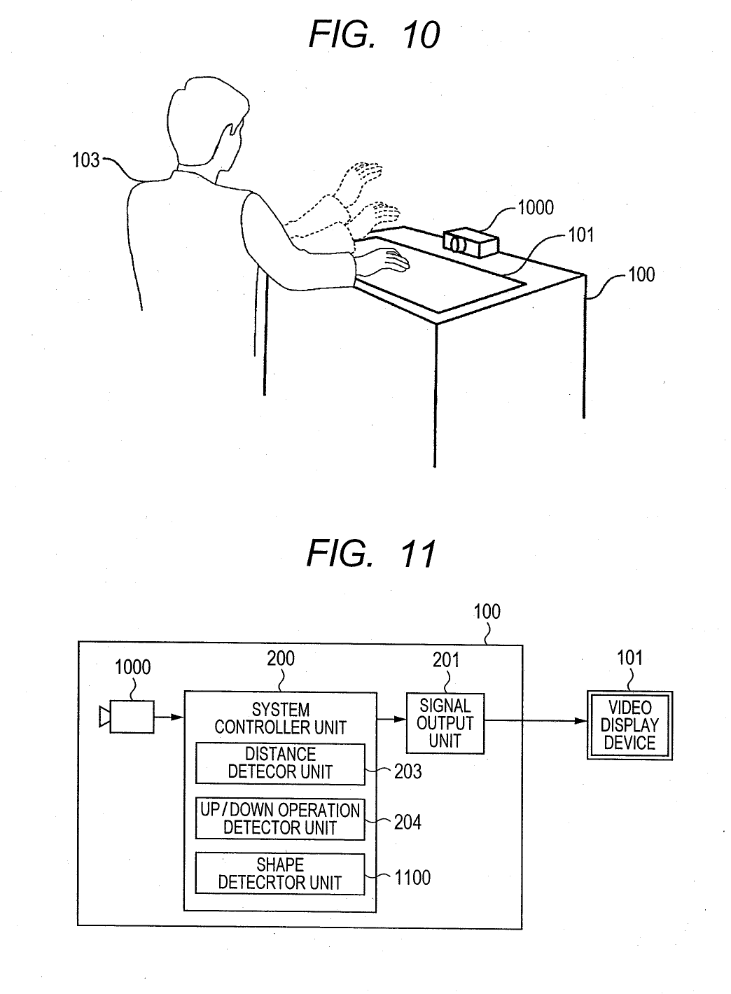

Hereinafter, explanation will be made of a third embodiment of the present invention, by referring to FIGS. 10 through 13.

The display controlling method of the input apparatus 100 according to the first embodiment is achieved for the purpose of providing an interface for executing the operation depending on change of the operating area where the hand locates. According to the present embodiment, in addition to the operation method of the first embodiment, there is further provided determination of a detection criterion for detecting the detection, depending upon a shape of the hand, when detecting the distance between the hand and the input apparatus 100.

Also, the input apparatus 100 according to the present embodiment, as will be shown in FIGS. 10 and 11, is constructed with the system controller unit 200 and the signal output unit 201, similar to the first embodiment; however, it differs therefrom in aspects that the sensing unit 102 is replaced by a camera unit 1000 and that the system controller unit 200 has a shape detector unit 1100.

The camera unit 1000 is a device for picking up an image of the hand of the user, and may be made up with, for example, an infrared camera having a TOF (Time Of Flight) sensor function, a stereo camera, an RGB camera, etc. The camera to be applied in the camera unit 1000 should not be limited to, in particular, but it may have a function of obtaining an image or picture picked up, for converting the picture into digital data.

The shape detector unit 1100 is a portion for detecting a predetermined shape of the hand, from the picked-up image or picture obtained from the camera unit 1000, wherein, for example, an image analyzing method may be applied, such as, a pattern matching, etc. The image analyzing method to be applied in the shape detector unit 1100 should not be restricted to, in particular, and may have a function of determining on whether there is the predetermined shape of the hand or not within the image obtained, and also a function of detecting the distance and the position of the hand.

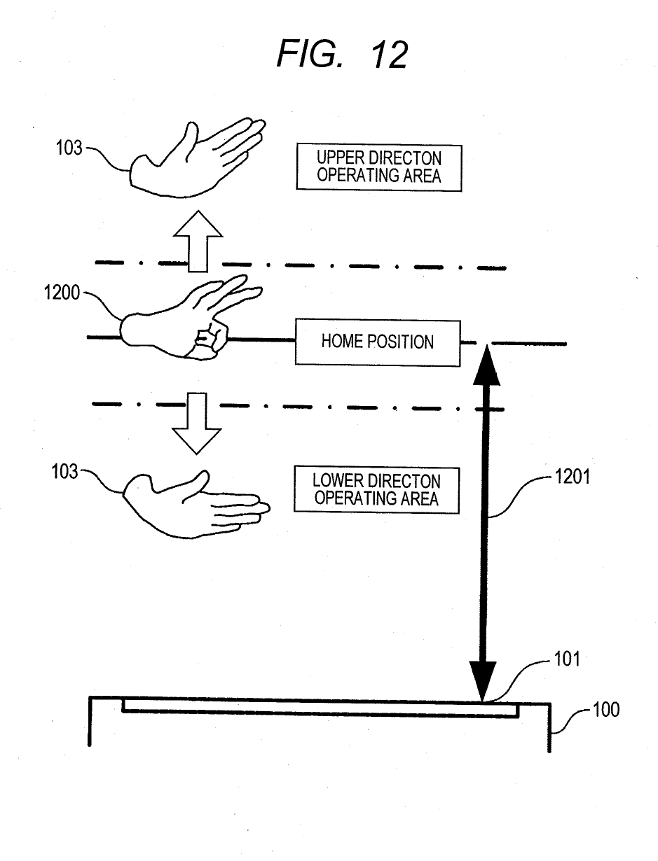

First of all, explanation will be given about the detecting method of an operation on the input apparatus 100 according to the third embodiment of the present invention, by referring to FIG. 12. This FIG. 12 is an overview for explaining about the detection criterion used by the input apparatus according to the third embodiment of the present invention, and also the operation by the user.

As is shown in FIG. 12, the input apparatus 100 detects the shape 1200 of the hand, among from the image obtained from the camera unit 1000, and determines the distance between the input apparatus 1000 and the hand of the user 103 at the time when detecting the shape 1200 of the hand, as a detection criterion 1201. Further, the input apparatus 100 changes the position of the operating area, which was shown in the first embodiment, depending on the detection criterion 1201 mentioned above. The operation after changing the operating area is same to that of the first embodiment.

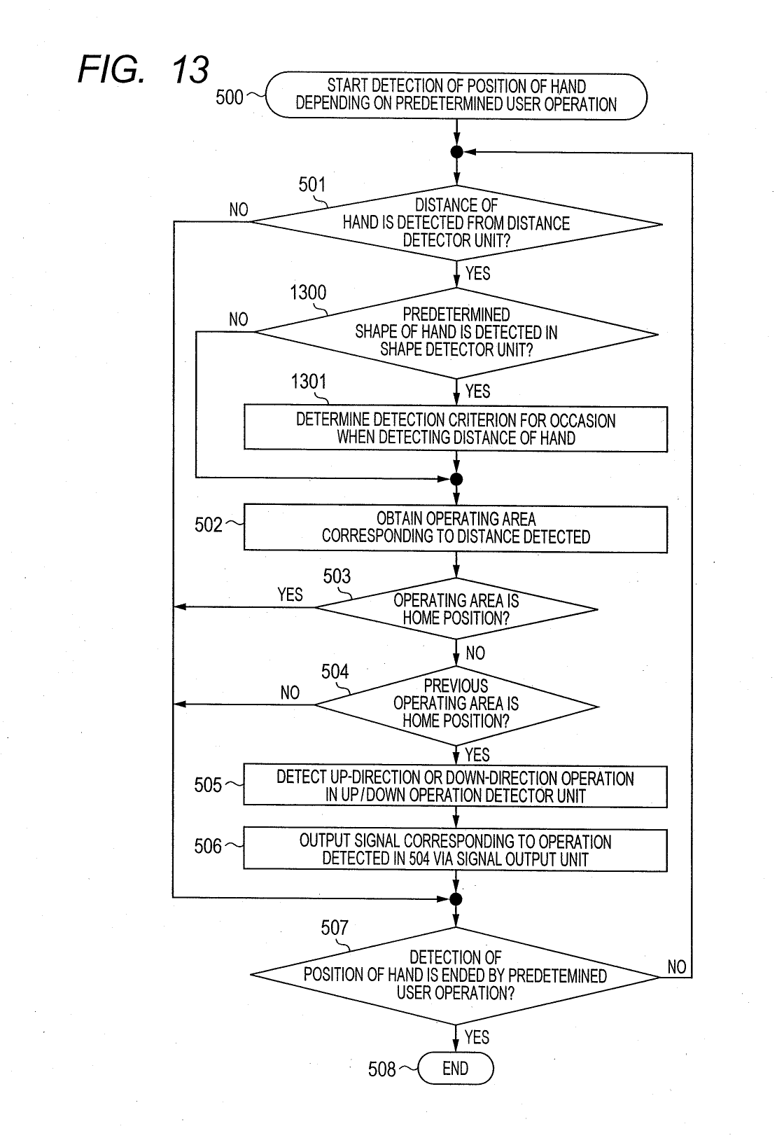

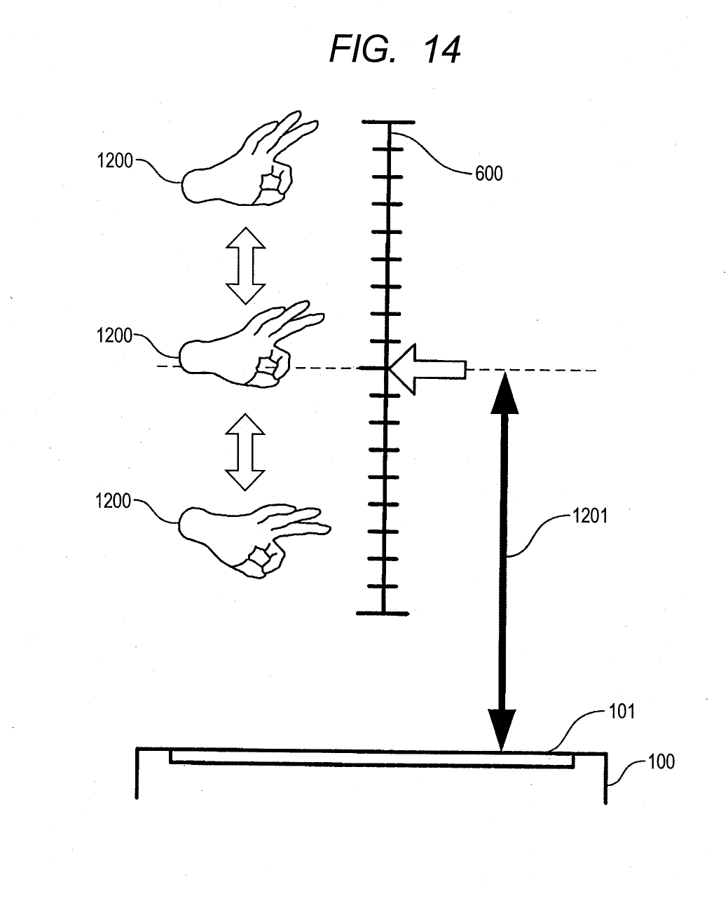

Next, explanation will be given about steps of a process for detecting an input operation by the input apparatus according to the third embodiment of the present invention, by referring to FIG. 13. This FIG. 13 shows a flowchart of adding steps 1300 and 1301 to those of the flowchart shown in FIG. 5, which was explained in the first embodiment.

The process for detecting the input operation is executed by the system controller unit 200 shown in FIG. 11.

First of all, the system controller unit 200, starting detection of the position of the hand (step 500) responding to the predetermined user operation, detects the hand from the images obtained from the camera unit 1000 within the distance detector unit 202, and passing through the processes for extracting or classifying the distance to be detected as the operation, it detects the distance of the hand. When the distance of the hand is detected (step 501), a process is executed for detecting the predetermined shape 1200 of the hand (step 1300), within the shape detector unit 1100. If the predetermined shape of the hand is detected (Yes: step 1300), the detection criterion is determined, to be applied when detecting the distance of the hand, and thereafter the processes are executed, e.g., those following the step 502. On the other hand, if the predetermined shape of the hand is not detected (No: step 1300), then the detection criterion is not determined, and the processes are executed, e.g., those following the step 502. About the processes following the step 502 are same to those of the flowchart shown in FIG. 5.

In this manner, the input apparatus 100 according to the third embodiment of the present invention determines the detection criterion 1201 depending on the shape of the hand, which is held up by the user 103 towards the input apparatus. With this, the user 103 can change the relative position between the hand and the operating area, at the timing intended, and therefore it is possible for the user 103 to input the operation at an arbitrary position with much more certainty.

### Embodiment 4

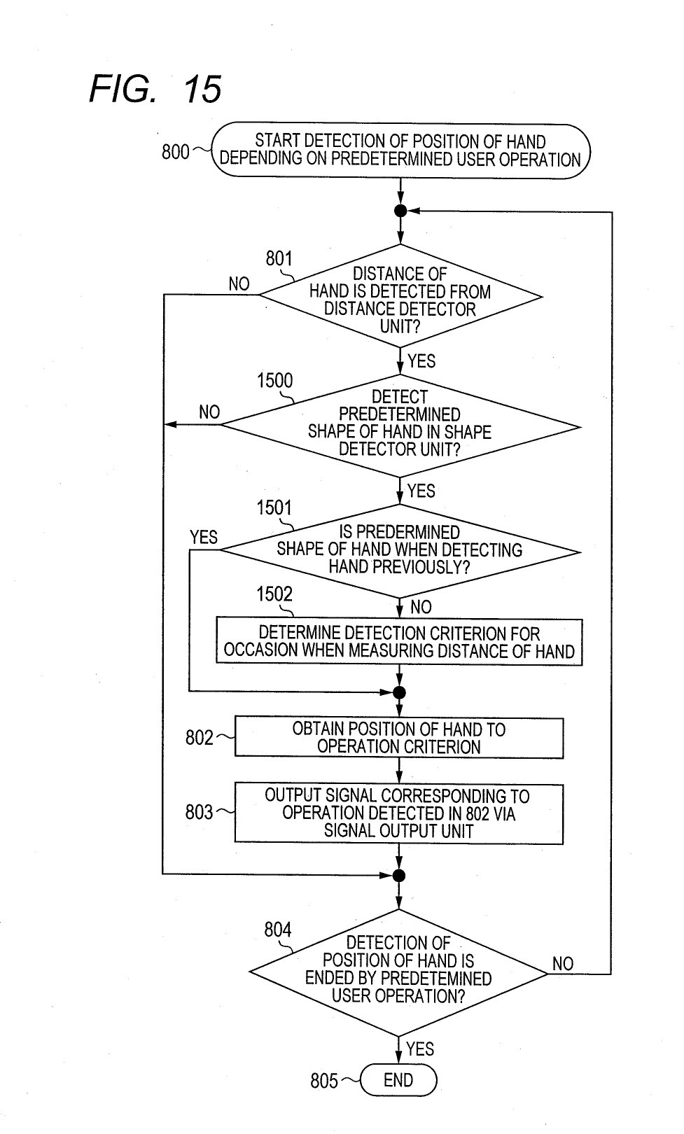

Hereinafter, explanation will be made on a fourth embodiment according to the present invention, by referring to FIGS. 14 and 15.

The display controlling method of the input apparatus 100 according to the third embodiment is achieved for the purpose of enabling to change the relative distance between the hand and the operating area at the timing intended, within the operation explained in the first embodiment, by determining the detection criterion 1201 depending on the shape of the hand. According to the present embodiment, in addition to the operating method of the third embodiment, there is further provided a means for enabling the change of the relative position between the hand and an operation criterion 600 at the timing intended, within the operation explained in the second embodiment.

In the input apparatus 100 according to the present embodiment, too, as is shown in FIGS. 10 and 11, there are provided the camera unit 1000, the system controller unit 200 and the signal output unit 201m similar to the third embodiment; however, it differs therefrom only in the steps of the detecting process, which is executed in the system controller unit 200.

First of all, explanation will be given about the method for detection the operation of the input apparatus 100 according to the fourth embodiment of the present invention, by referring to FIG. 14. This FIG. 14 is an overview for explaining about the detection criterion used by the input apparatus 100 according to the fourth embodiment of the present invention, and also the operation by the user.

As shown in FIG. 14, the input apparatus 100 detects the shape 1200 of the hand among from the images obtained from the camera unit 1000, and determines the distance between the input apparatus 100 and the hand of the user 103 at the time when detecting the shape 1200 of the hand, as the detection criterion 1201. Further, the input apparatus 100 changes the position of the operation criterion 600, which was shown in the second embodiment, depending on the detection criterion 1201 mentioned above. Also, the operations after changing the operation criterion 600 are effective only when detection of the shape 1200 of the hand continues, and about the operating method when the operations are effective, it is same to that of the second embodiment.

Next, explanation will be given about steps of a method for detecting the input operation by means of the input apparatus 100 according to the fourth embodiment of the present invention, by referring to FIG. 15. This FIG. 15 shows a flowchart of adding a step 1500 or a step 1502 to the flowchart shown in FIG. 8, which was explained in the second embodiment.

The process for detecting the input operation is executed by the system controller unit 200 shown in FIG. 11.

First of all, the system controller unit 200, staring detection of the position of the hand (step 800) responding to the predetermined user operation, detects the hand from the images obtained from the camera unit 1000, within the distance detector unit 202, and after passing the processes for extracting or classifying the distance to be detected as the operation, it detects the distance of the hand. When the distance of the hand is detected (step 801), a process is executed for detecting the predetermined shape 1200 of the hand (step 1500), within the shape detector unit 1100. In this instance, if the predetermined shape of the hand is detected (No: step 1500), the process does not advance to the following steps, but continues only the detection of the hand. Namely, only the case when the predetermined shape 1200 of the hand is detected, the operation becomes effective. On the other hand, if the predetermined shape 1200 of the hand is detected (Yes: step 1500), confirmation is made on whether it is the predetermined shape of the hand or not, at the time when detecting the hand previously (step 1501), and if determined that it is not the predetermined shape of the hand at the time when detecting the hand previously (No: step 1501), then the detection criterion is determined, to be applied when detecting the distance of the hand, and the processes following the step 802 are executed. Also, if determined that it is the predetermined shape of the hand at the time when detecting the hand previously (Yes: step 1501), the detection criterion 1201 is not determined, but the processes following the step 802 are executed. About the processes following the step 802, they are same to those of the flowchart shown in FIG. 8, which was explained in the second embodiment.

In this manner, the input apparatus 100 according to the fourth embodiment of the present invention determines the detection criterion 1201 depending on the shape of the hand, which is held up by the user 103 towards the input apparatus. Also, the operation becomes effective, only when the user holds up her/his hand in the predetermined shape thereof. With this, the user 103 can change the relative position between the hand and the operating area, at the timing intended, and further can make the operation only at the timing intended by the shape of the hand; therefore, it is possible for the user 103 to input the operation at an arbitrary position with much more certainty.

As was fully explained from the first embodiment through the fourth embodiment in the above, with the input apparatus and the input method according to the present invention, it is possible to grasp the operation corresponding, depending on the distance between the hand and the display screen, intuitively, and to improve the operability thereof.

Also, with the input apparatus and the input method according to the present invention, since the distance as the criterion is changed, dynamically, depending on the shape of the user's hand, when detecting the distance between the hand and display screen, there is no necessity of determining a timing for calibration on the way thereof, and thereby an improvement can be achieved of the operability.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An input method for operating an operation target displayed within a display screen, by a hand of a user, comprising the following steps of:
a step for detecting a distance form said display screen to the hand of the user; and
a display step for changing the operation target displayed within the display screen, depending on said distance detected.

2. The input method, as described in the claim 1, wherein in said display step, a scale of the operation target displayed within the display screen is made small, in case where the distance detected after movement of the hand of the user is larger than a predetermined distance, while the scale of the operation target displayed within the display screen is made large, in case where said distance detected after movement of the hand of the user is smaller than the predetermined distance.

3. The input method, as described in the claim 1, wherein in said display step, determination is made of a position of the hand of the user on an operation criterion, which is determined from the display screen in a direction perpendicular thereto, upon basis of the distance detected, and the operation target is displayed by the scale depending on the position of said hand.

4. The input method, as described in the claim 1, wherein
in case where the operation target displayed within the display screen is a hierarchical target,
within said display step, determination is made of a position of the hand of the user upon an operation criterion, which is determined from the display screen in a direction perpendicular thereto, upon basis of the distance detected, and the hierarchical operation target is selected and displayed deepening on the position of that hand.

5. An input apparatus for operating an operation target displayed within a display screen, by a hand of a user, comprising:
a sensor, which is configured to detect a distance form said display screen to the hand of the user; and
a controller unit which is configured to change the operation target displayed within the display screen, depending on said distance detected.

6. The input apparatus, as described in the claim 5, wherein said controller unit makes a scale of the operation target displayed within the display screen small, in case where the distance detected after movement of the hand of the user is larger than a predetermined distance, while making the scale of the operation target displayed within the display screen large, in case where said distance detected after movement of the hand of the user is smaller than the predetermined distance.

7. The input apparatus, as described in the claim 5, wherein said controller unit determines a position of the hand of the user on an operation criterion, which is determined from the display screen in a direction perpendicular thereto, upon basis of the distance detected, and displays the operation target by the scale depending on the position of said hand.

8. The input apparatus, as described in the claim 5, wherein
in case where the operation target displayed within the display screen is a hierarchical target,
said controller unit determines a position of the hand of the user upon an operation criterion, which is determined from the display screen in a direction perpendicular thereto, upon basis of the distance detected, and selects and displays the hierarchical operation target deepening on the position of that hand.
